(19) United States
(12) Patent Application Publication
(10) Pub. No.: US 2010/0262481 A1
(43) Pub. Date: Oct. 14, 2010

(54) METHOD, SYSTEM, AND COMPUTER PROGRAM FOR RECAPTURE OF AN ELECTRONIC DEVICE

(75) Inventors: James Baker, Vienna, VA (US); Peter Ellis, Lenexa, KS (US); Apoorv Kashyap, Reston, VA (US); Thomas Murphy, Overland Park, KS (US); Clint Pruett, Roeland Park, KS (US)

Correspondence Address: Hovey Williams LLP, 10801 Mastin Blvd., Suite 1000, Overland Park, KS, 66210, US

(73) Assignee: The Management Network Group, Inc., Overland Park, KS (US)

(21) Appl. No.: 12/756,059

(22) Filed: Apr. 7, 2010

Related U.S. Application Data
(60) Provisional application No. 61/167,678, filed on Apr. 8, 2009.

(51) Int. Cl. G06Q 30/00; G06Q 10/00; G06Q 50/00

(52) U.S. Cl. 705/14.23; 705/308

(57) ABSTRACT

A method, a system, and a computer program for recapturing electronic devices no longer of use to their owners. The method, which is implemented by the computer program, broadly comprises the steps of identifying at least one electronic device no longer of use to the device's owner by managing one or more identification parameters; matching the device with a recapture offer so as to incentivize the owner to donate or sell the device; notifying the device owner of the recapture offer; and acquiring the device from the owner to complete recapture of the device.

### RELATED APPLICATION

This non-provisional patent application claims priority benefit, with regard to all common subject matter, of earlier-filed U.S. Provisional Patent Application No. 61/167,678, filed Apr. 8, 2009, and entitled “COMPUTER SOFTWARE, METHOD, AND SYSTEM FOR GLOBAL ASSET IDENTIFICATION MATCHING NOTIFICATION AND ACQUISITION (IMNA) SYSTEM.” The identified earlier-filed provisional application is hereby incorporated by reference in its entirety into the present application.

### BACKGROUND

1. Field

Embodiments of the present invention provide a method, a system, and a computer program for the proactive recapture of an electronic device or asset, such as a wireless communications device, from an owner who no longer has use for the device.

2. Related Art

Electronic devices, such as wireless communications devices, are often replaced every several months to several years by their owners. As technology advances and as the owner of the device desires upgrades, additional features, or a better operating device, these devices are no longer of use to their owners. Because the devices are relatively small (in physical size) and most device retailers either do not have a buy-back program or the device's resale value at a retail location is minimal, the electronic devices are often disposed of by the owners, either through throwing away or simply storing.

Unfortunately, these types of frequently replaced electronic devices have toxic or hazardous substances that, when the electronic device is thrown away, enter the waste stream. Further, the economic value of the devices is not necessarily exhausted upon the owner no longer having a use for the device. For example, providers of the devices or services associated with the devices (collectively “providers”) could realize value through refurbishing the devices for retail operations and insurance replacements, as parts for service and repair organizations, and as potential resale opportunities. However, because of the owners' difficulty in selling the used device on the retail market, the devices' value is never realized.

Accordingly, there is a need for a method, a system, and a computer program that removes the passive searching and selling of the device by the owner and instead proactively recaptures the device from the owner.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

The present invention facilitates the timely recapture of specifically targeted electronic devices through proactive communication with properly matched/qualified owners of the devices. Embodiments of the present invention serve as a collection point for many different types and models of devices and across many different providers. For example, embodiments of the present invention allow various wireless communications carriers to recapture devices from both their own customers and from other carriers' customers, thus insuring the broadest coverage and potential pool of customers from whom to recapture devices.

Embodiments of the present invention identify owners of targeted recapture devices, match the owner's device with any offers to incentivize the owner's donation or sale of the device, notify the owner of the recapture option, and acquire the device from the owner. Additional detail of these broad steps of the invention are provided below.

### BRIEF DESCRIPTION OF THE DRAWINGS

Embodiments of the present invention are described in detail below with reference to the attached drawing figures, wherein:

FIG. 1 is a schematic of a system for recapturing an electronic device no longer of use to an owner according to embodiments of the present invention;

FIG. 2 is a schematic illustrating myriad types of electronic devices for recapture by the system of embodiments of the present invention;

FIG. 3 is a schematic illustrating the system of FIG. 1 in additional detail; and

FIG. 4 is a flow chart of certain steps of embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present invention provide a method and a system 10 that may be implemented via a computer program for assisting a service provider, hereinafter “provider,” in recapturing a device 12 from an owner who no longer has use for the device. The steps of the method of the present invention are performed via corresponding code segments forming the computer program, as discussed in more detail below.

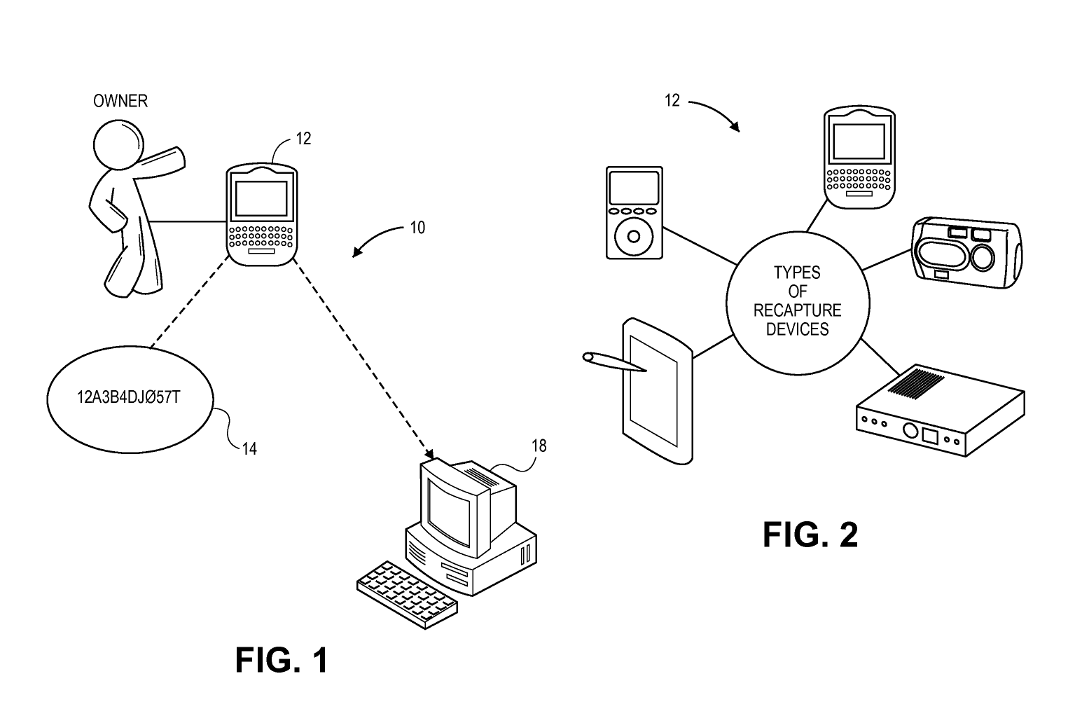

In embodiments of the present invention and referring to FIGS. 1-3, the device 12 is a wireless communications device, such as a mobile handset; a personal digital assistant; a computer, including a laptop computer; a media-playing device, such as an IPOD® or a KINDLE®; a cable set-top box; a satellite TV receiver; a digital video recorder; a digital camera; or any other electronic device for which the owner no longer has use for the device. Although the owner no longer has use for the device, such devices often have use for others as refurbished devices for subsequent sale to new owners, as insurance replacements, as a source of replacement parts for service and repair organizations, or for resale to new owners. Therefore, a wear life of the device, or a portion thereof, is not necessarily exhausted upon the owner no longer having use for the device. As can be appreciated, the device, or a portion thereof, may have several owners, each of which subsequently expends their respective use of the device, or the portion thereof. Embodiments of the present invention can then be employed to recapture the device from the present owner. Reference to the “device” herein is specifically understood to include the device or a portion thereof, such as a component or part of the device. Additionally, the device for recapture is referred to herein as the “target device,” the “recaptur[ed] device,” or simply the “device.” Furthermore, the present invention will be described with respect to recapture of a wireless communications device, although such is not intended to be limiting.

In embodiments of the present invention, the device 12 has a unique identifier 14, such as an equipment serial number (“ESN”). The unique identifier assists in properly identifying or otherwise locating the device and can be used as an identifier for tracking of the device during its lifetime. The unique identifier may be a bar code, a string of letters, numbers, or a combination thereof, or any other form of uniquely identifying the device.

The service provider or “provider” referenced herein is any entity interested in or willing to obtain a recaptured device. An exemplary, although not exhaustive, list of providers includes wireless communications carriers, mobile handset manufacturers, satellite carriers and satellite box manufacturers, digital camera manufacturers, entities who insure or warrant the devices, and parts providers for replacement parts or components for the devices.

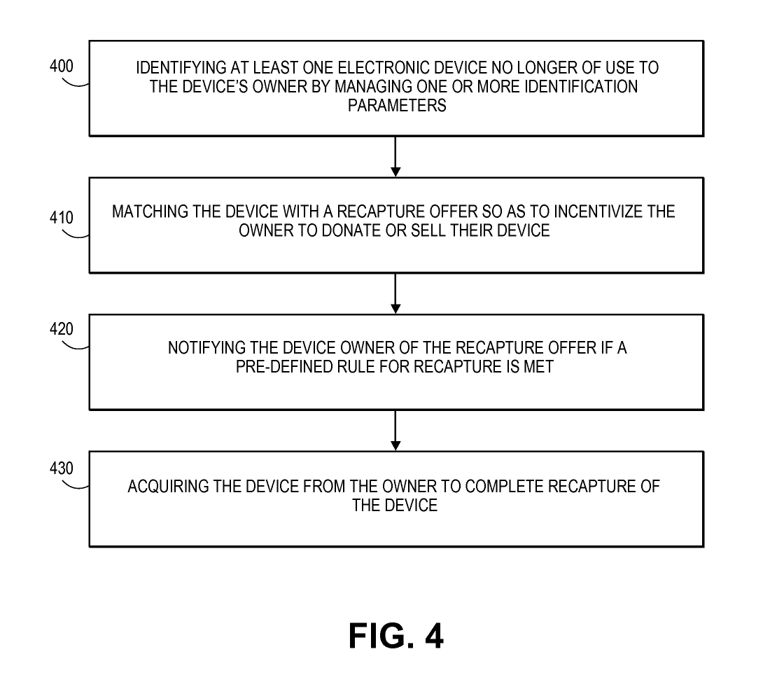

Referring to FIG. 4, the device recapture method of embodiments of the present invention broadly comprises the steps of identifying the device no longer of use to the owner, matching the device with a recapture offer so as to incentivize the owner to donate or sell their device, notifying the owner of the recapture offer, and acquiring the device from the owner for recapture. The method of embodiments of the present invention can be implemented via the Identification, Matching, Notification, and Acquisition (“IMNA”) system 10 described herein. The system is preferably embodied in the computer program, discussed below, accessible via a website or, alternatively, through software loaded on or accessible by a user of the present invention.

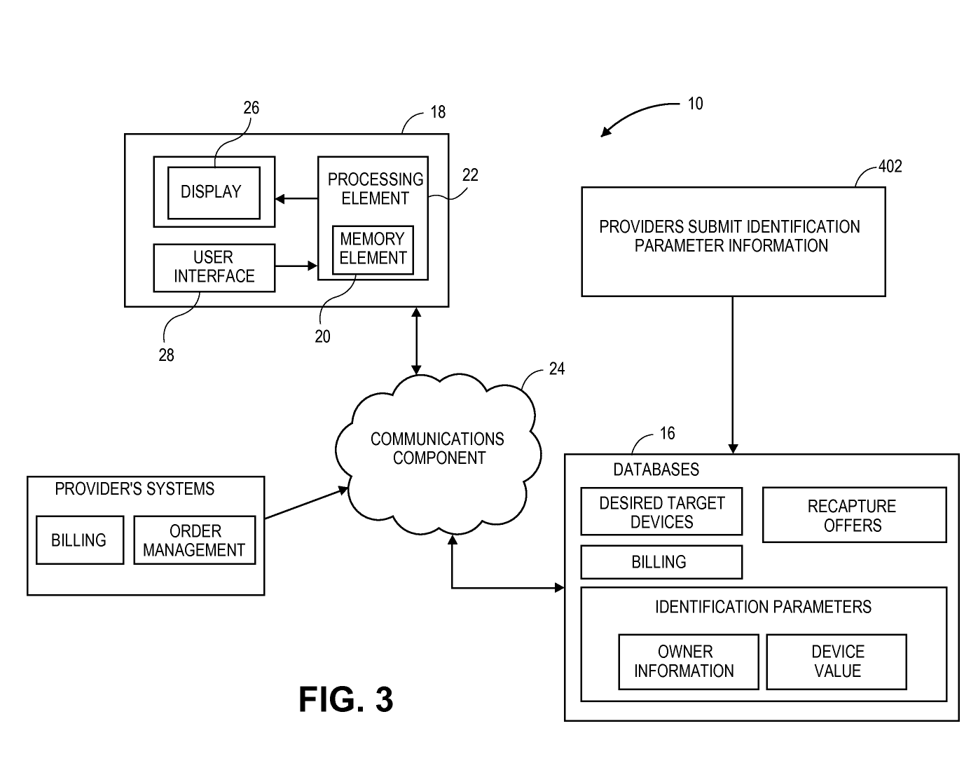

Referring to FIG. 3, in embodiments of the present invention, multiple providers provide data feeds to various databases 16 accessible by the computer program. Exemplary databases include a desired target device database and an owner database (i.e., a database of the provider's customers who own devices), and other databases will be referenced throughout. Because the IMNA system 10 has both a supply of potential recapture devices and a supply of providers desiring to obtain recaptured devices, the IMNA system more readily, efficiently, and responsively performs the identification, matching, notification, and acquisition steps of the present invention. As can be appreciated, a wider selection of potential target devices across multiple providers will assist in performing the steps of the method of the present invention with improved efficacy.

The flow chart of FIG. 4 depicts the steps of exemplary methods of the invention in more detail. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

### Identification

The present invention proactively identifies those devices 12 no longer of use to the corresponding owner, as illustrated in Step 400 of FIG. 4. This is in contrast to a provider waiting for the owner to notify the provider that it wishes to disencumber itself from the device (either through donating or selling the device). To identify a potential or target recapture device 12, embodiments of the present invention identify, obtain, or otherwise manage one or more identification parameters, discussed in detail below. Exemplary identification parameters broadly include a trigger event or “trigger,” such as the device owner's changed circumstance or a pre-defined event; known device features; or a combination thereof.

The IMNA system 10 and computer program of the present invention receive information indicating or identifying one or more identification parameters from data feeds from the providers and other parties associated with the present invention, as denoted at Box 402 of FIG. 3. For example, the providers subscribing to the IMNA system will periodically upload information to an Identification Parameter database accessible by the computer program of the present invention. As discussed in more detail below, the information may include device owner information, identification of device owners who have recently realized changed circumstances, known device features, and other information corresponding to or associated with the identification parameters, hereinafter referred to as the “identification parameter information.”

At pre-set times, as instructed by an implementer or provider of the present invention, the computer program filters the identification parameter information to identify devices potentially no longer of use to their owners. Alternatively, the computer program automatically filters the identification parameter information upon receipt of a new data feed from a provider corresponding to new information. The implementer and/or the provider can set baseline values for each identification parameter, such that the computer program of the present invention only identifies those devices meeting one or more of the baseline values.

In embodiments of the present invention, the IMNA system 10 and computer program can identify target devices based on, at the least, the device owner's changed circumstances. For example, if the device owner is an owner of a wireless or mobile handset, and the device owner visits a retail wireless communications carrier to upgrade or purchase a new wireless handset, then the device owner is realizing a changed circumstance. This circumstance can be used as an identification parameter, when provided to the IMNA system, to identify a potential recapture device, i.e., the old device that the owner is upgrading. In conjunction with the owner's changed circumstance, the computer program can also filter the known information of the model of the owner's device. If the model is not of a type that is desirable for recapture, i.e., does not meet a baseline value, then the device is not identified as one available for recapture.

An exemplary, although not exhaustive, list of device owner's changed circumstances include device owners upgrading their devices, disconnecting their devices, such as terminating a service contract, or churning. Churning, as known in the art, is the attrition of a customer/owner from a provider or a customer/owner leaving one provider to go to another provider. Target recapture devices can also be identified by a predictive-churn method, wherein likely churn customers, such as owners of mobile handsets more than two years old, are identified and then incentivized to upgrade their devices and/or extend their contract. Owners of target recapture devices also can be identified by a customer or subscriber identifier or the customer's payment history. For example, a device owner could be provided a customer identifier that identifies the owner as frequently (e.g., every one to two years) replacing their device. Regardless of the known device in the owner's present possession, the method of embodiments of the present invention may identify the owner as an owner of a device for target recapture due to the knowledge that the owner often replaces their device.

In some circumstances, the pre-defined event will serve as a trigger for identification of a recapture device. Exemplary pre-defined events include an owner providing a new purchase request, a service disconnect request, a number port request, an electronic serial number (“ESN”) swap, or a device owner simply accessing the IMNA system to inquire about donating or giving away their device. Other pre-defined events are possible, and the above list is not intended to be exhaustive. Additionally and as can be appreciated, some identification parameters may fall into either of the owner changed circumstances or pre-defined events categories, such as a new device purchase request.

Embodiments of the present invention may also identify target recapture devices based on known features of the owner's device, such as a type or a model of the device or an estimated device value. For example, devices of a high initial value, even after several months to several years use, may be more attractive for potential recapture than a device that was initially relatively inexpensive. The computer program of the present invention would then only identify devices having a value equal to or above the baseline value set by the implementer of the present invention or the provider. The present invention may also employ industry depreciation tables that identify the value of devices after a certain time of wear or use. The invention may also identify devices based on known components or parts.

Any one or combination of the above triggers (device owner's changed circumstances or the pre-defined event) and known device features may be used to identify owners of target recapture devices, and it may be that a particular identification parameter is embodied in one or more of the above-listed categories of parameters. Further, the provider can selectively choose which combination of identification parameters is suitable for target devices, and such identification parameters are not necessarily static and may be dynamic over a certain time period.

In addition to the providers, the IMNA system 10 may receive the identification parameter information from multiple, independent sources, such as industry experts on pricing of devices or demographic information on purchases by certain owners. In embodiments of the present invention, it is preferred that the system is supplied with information corresponding to a particular identification parameter from a plurality of independent feeds or sources. For example and as noted above, it is preferred that the IMNA system receives information from multiple providers of triggers. This increases the flexibility of the permutations of identification parameters and addresses changing interests, goals, and needs of each provider.

For example, during a given calendar year, the provider may wish to identify owners of potential recapture devices 12 based on different identification parameters or based on weighing certain parameters more than other parameters (e.g., the value of the device is more important than the components or parts of the device). It may be that the provider desires to recapture more of a certain type of device or to only recapture devices of a certain age. Because the identification parameters and the corresponding information are constantly changing, and further because a particular provider's needs are constantly changing, periodic updates of the identification parameters, the identification parameter information, the baseline values for each identification parameter, as appropriate, and the weight accorded to each parameter, are advantageous.

The time period between updates or data feeds of identification parameter information is dependent on a number of factors, and it may be that the implementer and/or the provider specify that some identification parameter information is updated more frequently than other parameters. Preferably, the method of the present invention allows the provider to select the preferred identification parameters and the update period. In alternative embodiments, the present invention may suggest identification parameters and update periods to the provider to assist with the identification of target devices based on the provider's needs.

In even further alternative embodiments of the present invention, the target device may be identified by affirmative contact from the owner expressing an interest in having their device 12 recaptured. The contact from the owner could be initiated by the owner or could be in response to a communication from the IMNA system 10 and/or the provider of the potential opportunity for recapture of the device. For example, the IMNA system could receive a text message initiated by the owner that acts as the trigger to identify the owner's device and initiate the matching and notification steps and return a “value” to the owner via text message. For example, this feature can be used to support a retail presence that communicates to owners that to understand what their device may be worth, simply text “value” to “123456.”

### Matching

After identifying those devices 12 no longer of use to the device's owner, embodiments of the present invention match the target device with a provider's recapture offer, as illustrated in Step 410 of FIG. 4. As can be appreciated, the steps of identifying the target recapture devices and matching the devices with the provider's offer may be performed alone or in conjunction. For example, in some circumstances, the present invention may identify target recapture devices based on a trigger that commonly results in easily recapturing a device, such as the owner of the device purchasing a newer device at a retail location. Under this circumstance, embodiments of the present invention may not have yet matched the device with a particular provider's offer. However, in other embodiments of the present invention, the device may not be identified pursuant to the steps described above until the provider requests a device having particular features. In such a case, the identification and matching of the device, pursuant to the steps of the present invention, may be performed generally simultaneously. In even further embodiments, an implementer of the IMNA system 10 may simply recapture devices from their owners, such as a point of sale of a new device, and only match the recaptured device with a recapture offer after acquisition of the recaptured device.

To perform the matching of the identified target device with the provider's offer, one or more pre-defined rules for the recapture offer are inputted into the system 10 and computer program of the present invention. The pre-defined rules may be provided by the provider who is to receive the recaptured device, may be established by regulations of a particular industry in which the device may be used, and/or may be established by the implementer of the present invention. If the rules are provided by the provider, the rules may embody, in some instances, the identification parameters set forth above that are particular to the provider.

The pre-defined rules assist in matching a particular provider's recapture offer with identified target devices by (1) enabling filtering and/or comparison of the potentially massive amount of received information corresponding to the potentially numerous target devices, identification parameters, and pre-defined recapture offer rules; (2) routing commands from the involved parties, including the provider, the device owner, and the implementer of the present invention; and (3) properly implementing timing of the identification and matching steps.

To conduct the matching step, embodiments of the present invention may process data from multiple providers' systems and/or multiple databases accessible by the computer program of the present invention, which are discussed in more detail below. An exemplary matching may comprise the steps of receiving the trigger, such as the device owner requesting to cancel their service with the provider. The present invention then (1) compares identifying information for the device owner against data from an Owner database to identify the customer's/owner's name and type of device; (2) looks up a potential value of the device in a Device Value database; (3) after looking up the device's potential value, refers to a Recapture Offers database to verify that the device's potential value allows for providing the customer (i.e., owner of the device) an incentive to submit their device for recapture; and (4) refers to a Billing database to determine if the customer is in arrears and therefore, ineligible to participate in the program. As can be appreciated, the steps performed during matching of the device to a recapture offer will be dependent on various known and desired information, including the above-discussed triggers and known device features.

Matching can be executed with either batch or near-real time (i.e., very small repetitive batches executed by scripts) data feeds, depending on the needs of the provider and inputted preferences of the IMNA system. For example, in a case where a number port-out request is used as the trigger, there are time constraints associated with the cut-over service level agreements (“SLAs”) that may require near-real time processing. However, in the case of a device upgrade as the trigger, there are no such SLAs, and the matching may be processed in large batches to gain certain efficiencies in filtering, processing, and targeting.

### Notification

Once the matching of the device to a recapture offer is complete and the opportunity for a device recapture has been qualified or verified, the device owner is notified of the opportunity to have its old device recaptured, as illustrated in Step 420 of FIG. 4. In embodiments of the present invention, the device owner is notified according to a standard set by either the provider or the implementer of the system, such as a particular communications channel that directs the owners to the website hosting embodiments of the present invention. The owner may be notified via a variety of methods, including, without limitation, e-mail, short message service (“SMS”), multimedia messaging service (“MMS”), automated voice messages, and other suitable communications methods.

An exemplary notification for a highly valued device may be as follows: “Your [device] is worth [$xx] dollars, please visit [www.assetbuyback.com] to initiate the return process.” In contrast, the owner of a device of little economic value to the provider, but for which recapture is desirable for environmental reasons, may receive the following message: “For environmental purposes, [provider] would like to receive your device back via a donation program, please visit [www.assetdonation.com] to initiate the donation process.”

In an exemplary embodiment, the notification sent to the owner will highlight or identify the provider seeking to recapture the device via use of the present invention and the recapture offer. For example, the provider's recapture offer may allow the device owner to obtain an instant rebate on a new device if the device owner donates or provides the provider with the recapture device. Thus, in preferable form, the notification to the device owner of the opportunity to have their device recaptured includes identification of the pre-defined rules for the device recapture offer and any corresponding rules or regulations.

In more detail, using the established notification standards, the IMNA system may be configured to “brand” the notification for the provider, such as using the provider's trademarks in the notification; route the notification over a defined communication channel so as to ensure no cost liability to the device owner (e.g., costs for an SMS or text message); control the frequency and timing of any additional follow-up notifications; and tailor the messages to the device, its owner, and the recapture offer, such as identifying the owner and device by name in the notification as well as the potential value of the device. Additionally, the IMNA system tracks the owner's response to the notification, which allows the provider to modify its marketing strategies and/or enhance its program in accordance with the response rates.

In embodiments of the present invention, device owners who opt to respond to the notification/invitation to return their device are directed to a website branded for the particular provider. In alternative embodiments of the present invention and by employing pre-set preferences, the IMNA system may be configured to direct owners with high value devices to a personalized IMNA website that allows the owners to be streamlined through a registration and return process.

### Acquisition

After notifying the device owner of the opportunity to have their device recaptured, embodiments of the present invention acquire the device from the owner, as illustrated in Step 430 of FIG. 4. Acquisition of the recaptured device includes the steps of verifying and registering the device, shipping the device to the provider or implementer of the system, tracking the device, processing the device, and remunerating the device owner based on the recapture offer to complete the recapture process. If the owner opts to respond to the offer, the owner verifies, through the IMNA website or the provider's website, the device type and condition, such as by inputting the ESN, reviews the recapture offer's terms and conditions, and registers the device to accept the recapture offer. To effectively manage the device acquisitions, the IMNA system uses data from the provider's defined reverse logistics system (i.e., the provider's system that stores owner information, such as mailing address) to allow the device owner to print a pre-paid shipping label from the IMNA system's website.

Depending on the provider's pre-defined rules, the value of the device, and/or owner preference; shipping may be offered through standard package operators, including the United States Postal Service, UPS, Federal Express, etc. The shipping label preferably contains a bar code with embedded Return Material Authorization (“RMA”) information, including shipping address, device identification information, including the ESN, tracking codes, and other desired information that allows an implementer of the present invention and/or the provider to properly identify the returned device and match it to the appropriate recapture offer.

Once the package is received by the provider or designated recipient of the recaptured device, the device is processed. Although processing can embody various steps dependent on the internal logistics of the implementer of the present invention or the designated recipient of the device, in preferable methods, the shipping label is scanned and the enclosed device is verified against the recapture offer in the IMNA system 10 based on data provided on the shipping label. In embodiments of the present invention, the verification is either performed via the IMNA system's website or from the provider's receiving location or own website using information obtained from the IMNA system. If the device matches an open recapture offer, a valuation test specific to the provider is performed to ensure it meets the terms of the recapture offer (i.e., it is worthy of the incentive).

If the valuation test is passed, the IMNA system notifies the owner of the acceptance of their device and the authorization of the corresponding remuneration (e.g., gift card, bill credit, etc.) based on the provider's recapture offer. For example, in the case of a gift card, the IMNA system notifies the owner of a PIN associated with the offer that enables the owner to redeem a gift certificate. However, in the case of a bill credit, the IMNA system provides a report or data feed to the provider's billing group or system to trigger the credit on the owner's next billing statement. If incentive partners or vouchers are employed, these, too, are configurable to meet the provider's and partners' requirements.

In the event that the device does not match the pre-defined rules for the recapture offer, embodiments of the present invention include a set of rules to process the device appropriately. For example, the system may return the device to the owner or follow-up with the owner to determine if the owner will accept less money for the device or otherwise forgo the incentives previously offered.

If the valuation test is failed, a notification is sent to the owner via the IMNA system explaining the reason for the failure and the resulting invalidation of the offer. Similarly, if the device does not match an open offer, it may, depending on the provider's pre-set preferences, be evaluated for its value and, if sufficient value exists, an additional notification sent to the customer via the IMNA system explaining the discrepancy and any appropriate new offer.

As a result of the identification, matching, notification, and acquisition steps the IMNA system 10 performs, embodiments of the present invention include reporting capabilities to track any and all owner activity related to return notification messages, initial and subsequent visits to the IMNA system website or specific partner's website, open offers to return devices, closed requests to return devices, remuneration issued in support of returned devices, inventory of devices requested but not returned, and other processing steps.

The provider may also access the IMNA system and website to perform administrative and reporting duties, to input preferences, or to review detailed reports or performance dashboards of the recapture offer system.

As noted above, in operation, the method and IMNA system 10 of embodiments of the present invention are implemented via the computer program. It is to be understood that the computer program of the present invention can be accessible by known forms, such as an application accessible via a smart phone or wireless communications device, the above-described websites, or software accessible by the user, such as via the user's laptop or desktop computer and stored locally or remotely. As can be appreciated, the computer program is thus accessible via a user device 18 described in more detail below.

The user device 18 of embodiments of the present invention may be any computing device, such as, without limitation, a desktop computer, a laptop computer, a mobile communications device, such as a smart phone, a personal digital assistant, or any web-enabled device. The user device 18 may comprise any number and combination of processing elements 22, including processors, controllers, integrated circuits, programmable logic devices, or other data and signal processing devices for carrying out the functions described herein, and may additionally comprise one or more memory elements 20 (e.g., memory storage devices), transmitters, receivers, and/or communication busses for communicating with other user devices 18 operating the computer program of the present invention.

The computer program is comprised of a plurality of code segments for performing the steps and functions described herein. The computer program may thus comprise a listing of executable instructions for implementing logical functions in the user device 18. The computer program may be written in any suitable language but, in some embodiments of the present invention, is developed in Java and uses Unix and Oracle Relational Database Management System (“RDBMS”).

The computer program can be embodied in any computer readable storage medium or device for use by or in connection with an instruction execution system, apparatus, or device, and execute the instructions. In the context of this application, a “computer readable medium device” can be any means that can contain, store, communicate, propagate, or transport the program for use by or in connection with the instruction execution system, apparatus, or device. The computer readable medium device can be, for example, but not limited to, an electronic, magnetic, optical, electromagnetic, infrared, or semi conductor system, apparatus, device or propagation medium. More specific, although not inclusive, examples of the computer readable medium device include the following: a portable computer diskette, a random access memory (“RAM”), a read only memory (“ROM”), an erasable, programmable, read only memory (“EPROM” or flash memory), and a portable compact disk read only memory (“CDROM”), and combinations thereof.

The computer readable medium device and the computer program embodied thereon may be remotely accessible by the user device 18, such as via a web browser over the Internet or via a smart phone application. The various actions and functions described herein as being performed by or using the computer program may actually be performed by one or more computers, processors, or other computational devices, such as the user device 18 described herein, independently or cooperatively executing portions of the computer program.

The memory element 20 may be integral with the user device 18, may be stand alone memory, or may be a combination of both. The memory element may include, for example, removable and non removable memory elements such as RAM, ROM, flash, magnetic, optical, USB memory devices, and/or other memory elements. The memory element may store one or more of the databases described herein, code segments for accessing and using the databases, and/or other data for instructing the user device 18 to perform the functions and steps described herein. The memory element may comprise a plurality of memory elements located within the user device and/or located at a plurality of locations and accessible remotely via a communications component 24.

The communications component 24 may comprise a wireless transmitter/receiver, antenna, or any other wired or wireless devices operable to send and/or receive data signals to and from the user device 18. An exemplary communications component 24 is the Internet. In some embodiments of the invention, portions of the computer program, such as a particular database described herein, may be stored in locations or memory elements separate and remote from the user device 18. As such, the user device 18, via the communications component 24, is then operable to remotely access the remote databases. Thus, the communications component is configured for sending and receiving data regarding the identification parameters, the owner information, the device information, the pre-defined rules, the recapture offer, and the other items of information described herein.

The user device 18 preferably includes a display 26 comprising a graphical interface operable to display visual graphics, images, text, etc. in response to external or internal processes and commands and a user interface 28 for interfacing the user with the computer program of the present invention.

The display 26 may comprise conventional black and white, monochrome, or color display elements including CRT, TFT, LCD, and/or LED display devices. The display may be integrated with the user interface 28, such as in embodiments where the display is a touch screen display to enable the user to interact with it by touching or pointing at display areas to provide information to the user device. The display may be coupled with various other components of the user device and may be operable to display various information corresponding to the recaptured device information, the recapture offer, the owner information, etc.

The user interface 28 may enable one or more users to share information and commands with the user device 18 or IMNA system 10. The user interface may comprise one or more functionable inputs such as buttons, switches, scroll wheels, a touch screen associated with the display, voice recognition elements such as a microphone, pointing devices such as mice, touchpads, tracking balls, styluses, a camera such as a digital or film still or video camera, an optical scanner, and combinations thereof. The user interface may also include a speaker for providing audible instructions and feedback. Further, the user interface may comprise wired or wireless data transfer elements, such as the communication component, a removable memory, data transceivers, and a transmitter, to enable the user and other devices or parties to remotely interface with the user device or the system.

In embodiments of the present invention, the unique identifier 14 associated with the recaptured device 12 may be entered or scanned (as in the case of a bar code) into the computer program to obtain information regarding the device, such as recapture offers associated with the device.

The computer program of the present invention is, in some embodiments, operable via a plug-in-play module with the provider's existing computer systems and incentive programs. Exemplary computer systems include the provider's owner inventory, order management, and billing systems. Exemplary incentive programs include retention and loyalty programs. The computer program of the present invention also provides access to third-party incentive partners and shipping agents.

The computer program provides core capabilities such as a software interface (i.e., the interface of the computer program with a provider's internal software and systems), security, user/job management, data loading, and reporting. To effectively and efficiently process the potentially massive amount of data forming a part of the present invention, the IMNA computer program includes code segments for performing one or more of the following functions: data processing, matching, reconciliation, workflow, messaging, etc. Each function is configured specifically for a particular provider's internal software and systems.

As noted above, the identification parameter information and information corresponding to the various steps of the invention, such as the owner information, the device information, the recapture offers, etc., are provided to appropriate databases 16 accessible by the IMNA computer program via an initial baseline data feed and, thereafter, periodic, routine feeds from the provider. The data can be provided to the IMNA computer program and associated databases via a secure/file transfer protocol (“S/FTP”), an application programming interface (“API”), a web service, and/or any other suitable method. The S/FTP server may be located in either the provider's or the IMNA implementer's location and may be automatic (i.e., scheduled) or manual depending on the recapture offer, the owner information, and the provider's internal systems and capabilities.

Updating the information directly from the providers' systems and databases insures that the information relied upon and processed by the computer program of the present invention is accurate and complete. Preferably, all data processing, e.g., identification of potential target owners, notification of the owners, matching of the owners to a particular recapture offer, and acquisition of the device, takes place within the IMNA computer program. This advantageously avoids overly complicated development efforts to integrate disparate provider systems.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computer readable storage medium having a computer program stored thereon for assisting in recapturing electronic devices no longer of use to their owners, the computer program comprising:
a code segment for identifying at least one electronic device no longer of use to the device's owner by managing one or more identification parameters, said code segment including—
a code segment for setting baseline values for at least one of said identification parameters, wherein only devices meeting said set baseline values are identified as the at least one electronic device no longer of use to the device's owner,
a code segment for accessing information corresponding to the one or more identification parameters,
said identification parameters including, at least, a trigger and at least one known device feature,
said trigger including at least one of the device owner's indication of a desire to purchase a new device, a device owner disconnecting the device, a device owner churning, and a number port request,
said at least one known device feature including at least one of a type or a model of the device and an estimated device value, and
a code segment for filtering the identification parameters based on said set baseline values to identify the device no longer of use to the owner;
a code segment for matching the device with a recapture offer so as to incentivize the owner to donate or sell the device, said code segment including—
a code segment for establishing at least one pre-defined rule that must be met for successful matching of the device with the recapture offer, and
a code segment for determining if said pre-defined rule has been met;
a code segment for notifying the device owner of the recapture offer if said pre-defined rule is met; and
a code segment for acquiring the device from the owner to complete recapture of the device.

2. The computer program of claim 1, wherein the electronic device is selected from the group consisting of: a wireless communications device, a personal digital assistant, a computer, a media-playing device, a cable set-top box, a satellite TV receiver, a digital video recorder, and a digital camera.

3. The computer program of claim 1, further comprising a code segment for selecting which identification parameters are to be employed in identifying the device no longer of use to the owner.

4. The computer program of claim 3, wherein the information corresponding to the one or more identification parameters is obtained from service providers whose customers are owners of electronic devices.

5. The computer program of claim 4, wherein a first set of identification parameters is weighed more than a second set of identification providers in identifying the device no longer of use to the owner.

6. The computer program of claim 1, further including a code segment for notifying the device owner according to an established standard.

7. The computer program of claim 6, wherein the notification to the device owner includes identification of any rules or requirements of the device recapture offer.

8. The computer program of claim 6, wherein the established standard includes at least one of a defined message to the device owner; an instruction to route the notification over a defined communications channel; and a frequency and a timing of follow-up notifications.

9. The computer program of claim 1, wherein the code segment for acquiring the device from the owner to complete recapture of the device includes—
a code segment for verifying and registering the device,
a code segment for assisting the device owner in shipping the device,
a code segment for processing the device, and
a code segment for remunerating the device owner based on the recapture offer.

10. A method of recapturing electronic devices no longer of use to their owners, the method comprising the steps of:
identifying at least one electronic device no longer of use to the device's owner by managing one or more identification parameters, wherein said step further includes the steps of—
setting baseline values for at least one of said identification parameters, wherein only devices meeting said set baseline values are identified as the at least one electronic device no longer of use to the device's owner,
accessing information corresponding to the one or more identification parameters,
said identification parameters including, at least, a trigger and at least one known device feature,
said trigger including at least one of the device owner's indication of a desire to purchase a new device, a device owner disconnecting the device, a device owner churning, and a number port request,
said at least one known device feature including at least one of a type or a model of the device and an estimated device value, and
filtering the identification parameters based on said set baseline values to identify the device no longer of use to the owner;
matching the device with a recapture offer so as to incentivize the owner to donate or sell the device, said step including the steps of—
establishing at least one pre-defined rule that must be met for successful matching of the device with the recapture offer, and
determining if said pre-defined rule has been met;
notifying the device owner of the recapture offer if said pre-defined rule is met; and
acquiring the device from the owner to complete recapture of the device.

11. The method of claim 10, wherein the electronic device is selected from the group consisting of: a wireless communications device, a personal digital assistant, a computer, a media-playing device, a cable set-top box, a satellite TV receiver, a digital video recorder, and a digital camera.

12. The method of claim 10, further including the step of selecting which identification parameters are to be employed in identifying the device no longer of use to the owner.

13. The method of claim 12, wherein the information corresponding to the one or more identification parameters is obtained from service providers whose customers are owners of electronic devices.

14. The method of claim 13, wherein a first set of identification parameters is weighed more than a second set of identification providers in identifying the device no longer of use to the owner.

15. The method of claim 10, further including the step of notifying the device owner according to an established standard.

16. The method of claim 15, wherein the notification to the device owner includes identification of any rules or requirements of the device recapture offer.

17. The method of claim 15, wherein the established standard includes at least one of a defined message to the device owner; an instruction to route the notification over a defined communications channel; and a frequency and a timing of follow-up notifications.

18. The method of claim 10, wherein the step of acquiring the device from the owner to complete recapture of the device further includes the steps of—
verifying and registering the device,
assisting the device owner in shipping the device,
processing the device, and
remunerating the device owner based on the recapture offer.
